(19) United States
(12) Patent Application Publication
(10) Pub. No.: US 2020/0332225 A1
(43) Pub. Date: Oct. 22, 2020

(54) FABRIC-SCOURING COMPOSITION AND METHOD OF USE

(71) Applicant: SABIC GLOBAL TECHNOLOGIES B.V., BERGEN OP ZOOM (NL)

(72) Inventors: Sandeep Saxena, Karnataka (IN); Edward Joseph Nesakumar, Bangalore (IN)

(21) Appl. No.: 16/093,245

(22) PCT Filed: Apr. 18, 2017
(86) PCT No.: PCT/IB2017/052216

§ 371 Date: Oct. 12, 2018

(30) Foreign Application Priority Data
Apr. 22, 2016 (IN) 201611014185

(51) Int. Cl. C11D 1/825; D06L 1/12; D06L 4/75; C11D 3/43; C11D 3/20; C11D 3/395; C11D 11/00

(52) U.S. Cl. CPC C11D 1/825; D06L 1/12; D06L 4/75; C11D 3/43; C11D 1/72; C11D 3/3956; C11D 3/3953; C11D 11/0017; C11D 3/2068

(57) ABSTRACT

A surfactant concentrate includes, based on the total weight of the concentrate, 5 to 40 weight percent of a surfactant of the formula R¹(OCHCH₂)OH wherein n has an average value from 3 to 15 and R¹ is a combination of C₁₂₋₁₄ alkyl having an average value of C₁₃ or higher; 10 to 70 weight percent of a surfactant of the formula R²(OCHCH₂)ₘOH wherein m has an average value from 5 to 15 and R² is a C₁₃₋₁₈ alkyl or a combination of C₁₃₋₁₈ alkyl; 1 to 20 weight percent of a cosolvent; and the remainder water. A scouring bath and method of scouring textile using the concentrate are also disclosed.

### BACKGROUND

This application relates to compositions for treating fabrics, in particular cellulose-based fabrics such as cotton.

The process of converting raw cotton fiber to finished textile products is complex. Textiles generally go through various stages of production that includes yarn formation, fabric formation, wet processing, and textile fabrication. The textile obtained from the loom does not have desired properties such as absorbency, softening, or the like. Further, the textile is dirty or pale yellow, and is not used directly for making clothing or other articles (e.g., bedding, curtains, table linens, and the like). Additional wet processing renders the fabrics useful, particularly for apparel. Wet processing includes a series of processes, generally including desizing, scouring, bleaching, dyeing, printing, and finishing. Often the desize treatment by which the sizing materials is solubilized for the removal by washing may be carried out by enzyme solution. Caustic scours employing NaOH or KOH are also known. Scouring is an important step, and is the process by which natural and additive impurities such as oil, wax, fat, dust, and the like are removed to produce hydrophilic and clean fabric.

Nonyl phenol ethoxylates (NPEs) find numerous applications in textile production including the cotton scouring process. NPEs and octyl phenol ethoxylates (OPEs) are a type of nonionic surfactants generally referred to as alkyl phenol ethoxylates (APEOs). Alkylphenol ethoxylate surfactants are usually made from a branched-chain nonylphenol or octylphenol, reacted with ethylene oxide. Alkylphenol ethoxylates are biodegraded by removal of ethoxy groups, producing less biodegradable products: alkylphenol mono- and di-ethoxylates, alkylphenoxy acetic acid, alkylphenoxy polyethoxy acetic acids, and alkylphenols. These metabolites can persist through sewage treatment and in rivers. Anaerobic conditions generally lead to the accumulation of alkylphenols.

Eco-friendly scouring compositions accordingly remain a continuing need in the art.

### BRIEF DESCRIPTION

A surfactant concentrate comprises, based on the total weight of the concentrate, 5 to 40 weight percent of a surfactant of the formula R¹(OCHCH₂)ₙOH wherein n has an average value from 3 to 15 and R¹ is a combination of C₁₂₋₁₄ alkyl having an average value of C₁₃ or higher; 10 to 70 weight percent of a surfactant of the formula R²(OCHCH₂)ₘOH wherein m has an average value from 5 to 15 and R² is a C₁₃₋₁₈ alkyl or a combination of C₁₃₋₁₈ alkyl; 1 to 20 weight percent of a cosolvent; and the remainder water.

A scouring bath for a textile comprises 1 to 20 weight percent of the surfactant concentrate of any one or more of claims 1 to 9; and 0.1 to 10 weight percent of an oxidant, preferably a peroxide or a hypochloride; an amount of base effective to provide a basic pH; and the reminder water.

A method of scouring a textile comprises contacting the textile with the scouring bath for a time and at a temperature effective to scour the textile.

The above described and other features are exemplified by the following FIGURE, Detailed Description, and Examples.

### BRIEF DESCRIPTION OF THE DRAWING

The FIGURE is an exemplary embodiment illustrating a method of using the cotton-scouring composition.

### DETAILED DESCRIPTION

Described herein is an alkaline scouring bath with an eco-friendly scouring agent that effectively cleans natural cellulose fibers, while rapidly wetting the fibers. In particular, the composition is an alcohol-based, non-ionic surfactant formulation, which is particularly useful in cotton textile processing.

The composition comprises a polyethoxylate surfactant combination selected to have certain properties, in particular a C₁₀₋₁₈ fatty alcohol polyethoxylate with straight chain, methyl branching, or ethyl branching, and selected to have a hydrophilic-lipophilic balance (HLB) of 9.5 to 13.5.

Thus, the scouring agent in the scouring composition is a surfactant concentrate comprising, based on the total weight of the concentrate, 5 to 40 weight percent, specifically 10 to 35 weight percent, or 15 to 30 weight percent, or 10 to 30 weight percent, of a surfactant of formula (1)

R¹(OCHCH₂)ₙOH (1)

wherein n has an average value from 3 to 15 and R¹ is a C₁₂₋₁₄ alkyl having an average value of C₁₃ or higher. R¹ is straight chain, methyl branching, or ethyl branching, or a combination thereof. In an embodiment, n is 3 to 10, or 7 to 10, or 8 to 10.

The surfactant concentrate further comprise 10 to 70 weight percent, or 10 to 60 weight percent, or 20 to 60 weight percent, or 20 to 50 weight percent, or 30 to 70 weight percent, or 30 to 60 weight percent, of a surfactant of formula (2)

R²(OCHCH₂)ₘOH (2)

wherein m has an average value from 5 to 15 and R² is a C₁₃₋₁₈ alkyl or a combination of C₁₃₋₁₈ alkyl. R² is straight chain, methyl branching, or ethyl branching, or a combination thereof. In an embodiment, m is 5 to 12, or 7 to 10.

The surfactant concentrate further comprises 1 to 20 weight percent, or 5 to 10 weight percent, or 5 to 20 weight percent, or 10 to 20 weight percent of a cosolvent; and the remainder water. The cosolvent is selected to be effective to aid dissolution of the surfactant concentrate in the scouring bath. Suitable cosolvents can accordingly depend on considerations such as the particular surfactants, their final concentration in the scouring bath, the pH of the scouring bath, and any other components of the scouring bath. Possible surfactants include a glycol ether, an aliphatic or cycloaliphatic ether, e.g., tetrahydrofuran, an alcohol, e.g., methanol or ethanol, and the like.

Other surfactants known in the art can be present in addition. In a preferred embodiment, the surfactant concentrate does not include an alkylphenol ethoxylate or an anionic surfactant. In other embodiments no other surfactant is present.

In a preferred embodiment, the surfactant concentrate comprises, consists essentially of, or consists of, based on the total weight of the concentrate, 5 to 30 weight percent of a surfactant of the formula R¹(OCHCH₂)ₙOH wherein n has an average value of 9 and R¹ is a combination of C₁₂₋₁₄ alkyl having an average value of C₁₃ or higher; 10 to 60 weight percent of a surfactant of the formula R²(OCHCH₂)ₘOH wherein m has an average value from 5 to 12 and R² is a C₁₃₋₁₈ alkyl or a combination of C₁₃₋₁₈ alkyl; 5 to 15 weight percent of a cosolvent, preferably an alkyl glycol; and the remainder water.

The surfactant concentrate can be used in a scouring bath composition for a textile, in amounts generally known in the art. For example, the surfactants can be present in an amount of 0.001 to 5 weight percent, based on the total weight of the textile, or 0.01 to 3 weight percent, or 0.05 to 1 weight percent, or 0.05 to 0.5 weight percent, each based on the total weight of the textile (“owt”). Other surfactants known in the art can be present in addition in the scouring bath composition, but in a preferred embodiment, the scouring bath composition does not include an alkylphenol ethoxylate or an anionic surfactant. In other embodiments no other surfactant is present in the scouring bath composition.

The scouring bath composition can further comprise other components known in the art for such compositions, for example an oxidant, an oxidant stabilizer, a pH-adjusting agent, and the like, in amounts generally used.

The oxidant can be a peroxide, for example hydrogen peroxide, or a hypochlorite.

The pH-adjusting agent is added to activate the oxidant, such that a pH of about 7.0 to about 10.0, and preferably from about 7.5 to about 9.0, is achieved. The agent can be a caustic such as sodium hydroxide or potassium hydroxide; an alkali salts of organic acid, such as trisodium citrate, a transition metal salt or and complex, such as a copper salt or complex. It is also possible to use an organic activator, such as a urea, dicyandiamide or tetraacetylethylene diamine, or acetyl caprolactam; and certain pigments, e.g., pigmented Sulfur Black 1 with a particle size less than 150 μm; fully pre-oxidized sulfur dyes, such as Diresul Black 4G-EV, or titanium dioxide.

In a preferred embodiment, the scouring bath composition comprises 1 to 20 weight percent, or 5 to 15 weight percent, or 1 to 15 weight percent, or 10 to 20 weight percent of the surfactant concentrate; 0.1 to 10 weight percent of an oxidant, preferably a peroxide or a hypochlorite; an amount of base effective to provide a basic pH; and the reminder water.

Further disclosed herein is a method of scouring a textile, comprising contacting the textile with the scouring bath for a time and at a temperature effective to scour the textile. Steps and conditions are known in the art. An exemplary process is shown in the FIGURE, and described, for example, in US2006/0112495; and U.S. Pat. No. 4,080,164.

The textile can contain cellulosic fibers, or a combination of cellulosic fibers and synthetic fibers. It is also possible for each fiber to be a blend of a cellulosic and a synthetic material. Synthetic fibers include, for example, polyester and nylon.

In some embodiments, a textile, e.g., a cotton fabric scoured in the bath containing the surfactant concentrate, particularly 0.05% to 0.4% of the surfactants, based on the weight of the textile, has a result in the absorbency test AATCC no. 79-2007 of 6.0 seconds or less.

In some embodiments, a textile, e.g., a cotton fabric scoured in the bath containing the surfactant concentrate, particularly particularly 0.05% to 0.4% of the surfactants, has a result in the absorbency test AATCC no. 79-2007 of 1.0 seconds or less.

In some embodiments, a textile, e.g., a cotton fabric scoured in the bath containing the surfactant concentrate, particularly particularly 0.05% to 0.4% of the surfactants, has a result in the wicking test AATCC no. 197-2011 of 320.0 seconds or less.

In some embodiments, a textile, e.g., a cotton fabric scoured in the bath containing the surfactant concentrate, particularly particularly 0.05% to 0.4% of the surfactants, has a result in the wicking test AATCC no. 197-2011 of 200.0 seconds or less.

This disclosure is further illustrated by the following examples, which are non-limiting.

### EXAMPLES

The materials used are shown in Table 1.

TABLE 1

| Designation | Description (Trade designation) | Source |
|---|---|---|
| C12-14 alcohol/3EO | Naturally derived C12-14 fatty | SABIC |
| | alcohol ethoxylated with 3 mole | |
| | of ethylene oxide (SABICOL L-3) | |
| | (linear, primary, unsaturated | |
| | alcohol-based ethoxylate) | |
| C12-14 alcohol/7EO | Naturally derived C12-14 fatty | SABIC |
| | alcohol ethoxylated with 7 mol | |
| | of ethylene oxide (SABICOL L-7) | |
| | (linear, primary, unsaturated | |
| | alcohol-based ethoxylate) | |
| C12-14 alcohol/9EO | Naturally derived C12-14 fatty | SABIC |
| | alcohol ethoxylated with 9 mol | |
| | of ethylene oxide (SABICOL L-9) | |
| | (linear, primary, unsaturated | |
| | alcohol-based ethoxylate)) | |
| C13 alcohol/10EO | C13 alcohol ethoxylated with | |
| | 10 mol of ethylene oxide | |
| | (branched, unsaturated | |
| | alcohol-based ethoxylate) | |
| C13 alcohol/7EO | C13 alcohol ethoxylated with 7 | |
| | mol of ethylene oxide (branched, | |
| | unsaturated alcohol-based ethoxylate) | |
| DGMBE | Diethylene glycol monobutyl ether | |
| | (cosolvent) (unsaturated) | |

### Preparation of Surfactant Concentrates

Examples 1 to 5 were formulated as shown in Table 2, wherein amounts are in weight percent, based on the total weight of the composition. The compositions were produced by mixing the appropriate components, including heating where needed in order to achieve a homogenous solution.

TABLE 2

| | Example No. | | | | |
|---|---|---|---|---|---|
| Component | 1 | 2 | 3 | 4 | 5 |
| C12-14 alcohol/3EO | — | 5 | 5 | — | — |
| C12-14 alcohol/7EO | — | — | 20 | — | 25 |
| C12-14 alcohol/9EO | 10 | 10 | — | 25 | — |
| C13 alcohol/10 EO | 50 | 45 | — | 25 | 15 |
| C13 alcohol/7 EO | — | — | 25 | — | — |
| DGMBE | 10 | 10 | 8 | 10 | 10 |
| Water | 30 | 30 | 42 | 35 | 45 |
| Sodium Chloride | — | — | — | 5 | 5 |
| Total | 100 | 100 | 100 | 100 | 100 |

### Fabric Scouring

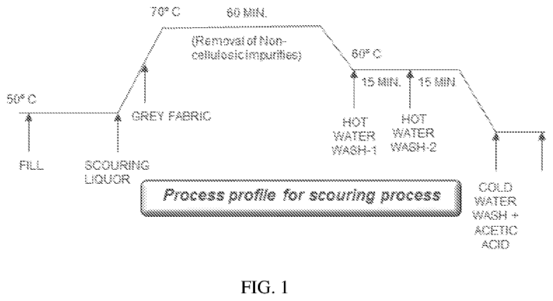

Fabric scouring was carried out as generally shown in the FIGURE. A section of 100% cotton grey knitted fabric of medium GSM (grams per square meter) after desizing was obtained from a textile process house. Prior to testing, each sample of fabric (100 g) was treated with an alkaline scouring process as shown in FIG. 1. This process is widely accepted in the industry.

In the process, the scouring tank was filled with 1 L of a scouring liquor at 50° C.

In the Examples, the scouring liquor included water, 2 to 10 grams (g) of flaked sodium hydroxide, 1 to 5 g of aqueous 50% hydrogen peroxide, and 2 to 10 g of the surfactant concentrate in an amount effective to provide a concentration of the surfactant (based on the weight of the fabric) shown in Table 5 below.

In a first comparative process, the scouring liquor (Comparative-1) contained no sodium hydroxide, hydrogen peroxide, or surfactant concentrate.

In a second comparative process, the scouring liquor (Comparative-2) contained sodium hydroxide and hydrogen peroxide, but no surfactant concentrate.

The test fabric was added to the scouring liquor, which was heated to 70° C. for 60 minutes. Then the fabric was removed from the scouring liquor and washed with hot water at 60° C. for 15 minutes, followed by a second hot water wash at 60° C. for 15 minutes. Finally the test fabric was washed with a dilution solution of water and (2 to 4 wt % acetic acid) at room temperature (20 to 25° C.).

The samples were tested in the same bath, or removed from the bath and tested directly without drying.

### Absorbency Test (AATCC 79-2007)

Test method AATCC 79-2007 was used to measure the water absorbency of textiles by measuring the time taken by a drop of water placed on the fabric surface to be completely absorbed into the fabric. First, the fabric sample was placed in an embroidery hoop with all creases smoothed out. Then a burette was used to dispense a drop of water onto the surface of the fabric from a distance of 9.5 mm above the fabric, and the time was recorded until the water drop was completely absorbed. Results are shown in Table 3, where the lower the numerical value, the more efficient the water absorbency.

TABLE 3

| Sample | Absorbency time (seconds) |
|---|---|
| Comparative-1 | Water drop did not absorb on fabric |
| [Fabric without chemical or | |
| surfactant] | |
| Comparative-2 | Water drop did not absorb on fabric |
| [Fabric with chemical without | for more than 300 sec. |
| surfactant] | |

| | Ex. 1 | Ex. 2 | Ex. 3 | Ex. 4 | Ex. 5 |
|---|---|---|---|---|---|
| Fabric at 0.05% surfactant | 2.4 | 4.3 | 7.4 | 5.0 | 9.0 |
| Fabric at 0.1% surfactant | 0.5 | 1.0 | 4.6 | 1.5 | 6.0 |
| Fabric at 0.2% surfactant | 0.3 | 0.7 | 2.6 | 0.9 | 3.7 |
| Fabric at 0.4% surfactant | 0.1 | 0.3 | 0.5 | 0.4 | 1.0 |

The results show that without the surfactant concentrate the absorbency time was greater than 300 seconds. Treatment with any of the surfactant concentrates of Examples 1 to 5 resulted in significant improvement of absorbency time. Example 1 (C12-14 alcohol/9EO+C13 alcohol/10 EO) provided the best results at each surfactant concentration. Examples 3 and 5, with a C12-14 alcohol/7EO but no C12-14 alcohol/9EO are not as effective. Further, the improvement for each composition is concentration-dependent, for example for composition 1 as the surfactant level varies from 0.05% to 0.4%, the absorbency time drops from 2.4 seconds to 0.1 second.

### Wicking Test (AATCC no. 197-2011)

Test method AATCC no. 197-2011 was used to evaluate the ability of vertically aligned fabric specimens to transport dye liquor along or through them. First, a 2% reactive dye solution (Reactive Red M5B) was prepared and poured into a petri dish. A piece of test fabric, with a mark 5 cm from one edge was suspended vertically above the petri dish such that one edge of the fabric was touching the surface of the dye solution, and such that the mark on the fabric was now 5 cm above the dye solution. The time was recorded when the dye solution had travelled up the fabric to reach the 5 cm mark. Results are shown in Table 4, where the lower the numerical value, the more efficient the wicking.

TABLE 4

| Sample | Wicking time (seconds) |
|---|---|
| Comparative-1 | Water drop did not absorb |
| | on fabric |
| Comparative-2 | Water drop did not absorb |
| | on fabric even after 600 sec. |

| | Ex. 1 | Ex. 2 | Ex. 3 | Ex. 4 | Ex. 5 |
|---|---|---|---|---|---|
| Fabric at 0.05% surfactant | 272 | 298 | 326 | 315 | 387 |
| Fabric at 0.1% surfactant | 195 | 210 | 240 | 228 | 274 |
| Fabric at 0.2% surfactant | 136 | 172 | 191 | 186 | 219 |
| Fabric at 0.4% surfactant | 85 | 98 | 108 | 102 | 140 |

The results show that without surfactant concentrate the water did not even absorb on the fabric, thus there is no wicking time to be listed. Treatment with any of the surfactant concentrates of Examples 1 to 5 resulted in significant improvement of absorbency time, with generally similar times, although Example 1 provided the best results. Further, the improvement for each composition behaved in a concentration-dependent manner, for example in Example 1, as the surfactant level varies from 0.05% to 0.4%, the wicking time drops from 272 seconds to 85 seconds.

### Comparative Study

A pre-treated sample of cotton fabric was treated for one hour at 70° C. with an amount of 0.2% Example 1, and a separate sample of cotton fabric was treated for one hour at 70° C. with a commercial scouring surfactant (an alkylphenol ethoxylate-free mixture of non-ionic surfactants) at the same concentrations. The fabric samples were then tested in both the absorbency test and wicking test as described above.

In the absorbency test, both the sample treated with Example 1 and the sample treated with the commercial product gave identical absorbency times of 0.3 to 0.4 seconds.

In the wicking test, the sample treated with composition-1 had a wicking time of 131±10 seconds and the sample treated with the commercial product had a similar wicking time of 116±6 seconds.

Thus, Example 1 has a comparable performance to a commercially-available formulation in these two tests.

The following embodiments illustrate but do not limit the invention.

Embodiment 1. A surfactant concentrate comprising, based on the total weight of the concentrate, 5 to 40 weight percent of a surfactant of the formula R¹(OCHCH₂)ₙOH wherein n has an average value from 3 to 15 and R¹ is a combination of C₁₂₋₁₄ alkyl having an average value of C₁₃ or higher; 10 to 70 weight percent of a surfactant of the formula R²(OCHCH₂)ₘOH wherein m has an average value from 5 to 15 and R² is a C₁₃₋₁₈ alkyl or a combination of C₁₃₋₁₈ alkyl; 1 to 20 weight percent of a cosolvent; and the remainder water.

Embodiment 2. The surfactant concentrate of embodiment 1, wherein the composition does not include an alkylphenol ethoxylate or an anionic surfactant.

Embodiment 3. The surfactant concentrate of embodiment 1 or 2, wherein n is from 3 to 10.

Embodiment 4. The surfactant concentrate of embodiment 1 or 2, wherein n is from 7 to 10.

Embodiment 5. The surfactant concentrate of embodiment 1 or 2, wherein n is from 8 to 10.

Embodiment 6. The surfactant concentrate of any one or more of embodiments 1 to 5, wherein m is from 5 to 12.

Embodiment 7. The surfactant concentrate of embodiment 6, wherein m is from 7 to 10.

Embodiment 8. The surfactant concentrate of any one or more of embodiments 1 to 7, wherein the compatibilizer is a glycol ether.

Embodiment 9. A surfactant concentrate comprising, based on the total weight of the concentrate, 5 to 30 weight percent of a surfactant of the formula R¹(OCHCH₂)ₙOH wherein n has an average value of 9 and R¹ is a combination of C₁₂₋₁₄ alkyl having an average value of C₁₃ or higher; 10 to 60 weight percent of a surfactant of the formula R²(OCHCH₂)ₘOH wherein m has an average value from 5 to 12 and R² is a C₁₃₋₁₈ alkyl or a combination of C₁₃₋₁₈ alkyl; 5 to 15 weight percent of a cosolvent; and the remainder water.

Embodiment 10. A scouring bath composition for a textile, comprising: 1 to 20 weight percent of the surfactant concentrate of any one or more of embodiments 1 to 9; and0.1 to 10 weight percent of an oxidant, preferably a peroxide or a hypochloride; an amount of base effective to provide a basic pH; and the reminder water.

Embodiment 11. A method of scouring a textile, comprising: contacting the textile with the scouring bath composition of embodiment 10 for a time and at a temperature effective to scour the textile.

Embodiment 12. The method of embodiment 11, wherein a cotton fabric scoured in the scouring bath composition containing the surfactants, preferably 0.05% to 0.4% of the surfactants, has a result in the absorbency test AATCC no. 79-2007 of 6.0 seconds or less.

Embodiment 13. The method of embodiment 11 or 12, wherein a cotton fabric scoured in the scouring bath composition containing the surfactants, preferably 0.05% to 0.4% of the surfactants, has a result in the absorbency test AATCC no. 79-2007 of 1.0 seconds or less.

Embodiment 14. The method of any one or more of embodiments 11 to 13, wherein a cotton fabric scoured in the scouring bath composition containing the surfactants, preferably 0.05% to 0.4% of the surfactants, has a result in the wicking test AATCC no. 197-2011 of 320.0 seconds or less.

Embodiment 15. The method of embodiment 14, wherein a cotton fabric scoured in the scouring bath composition containing the surfactants, preferably 0.05% to 0.4% of the surfactants, has a result in the wicking test AATCC no. 197-2011 of 200.0 seconds or less.

The compositions, methods, and articles can alternatively comprise, consist of, or consist essentially of, any appropriate components or steps herein disclosed. The compositions, methods, and articles can additionally, or alternatively, be formulated so as to be devoid, or substantially free, of any steps, components, materials, ingredients, adjuvants, or species that are otherwise not necessary to the achievement of the function or objectives of the compositions, methods, and articles.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combinations” is inclusive of blends, mixtures, alloys, reaction products, and the like. The terms “first,” “second,” and the like, do not denote any order, quantity, or importance, but rather are used to denote one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “some embodiments,” “an embodiment,” and so forth, means that a particular element described in connection with the embodiment is included in at least one embodiment described herein, and may or may not be present in other embodiments. In addition, it is to be understood that the described elements may be combined in any suitable manner in the various embodiments.

Unless defined otherwise, technical and scientific terms used herein have the same meaning as is commonly understood by one of skill in the art to which this invention belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A surfactant concentrate comprising, based on the total weight of the concentrate,
5 to 40 weight percent of a surfactant of the formula R¹(OCHCH₂)ₙOH wherein n has an average value from 3 to 15 and R¹ is a combination of C₁₂₋₁₄ alkyl having an average value of C₁₃ or higher;
10 to 70 weight percent of a surfactant of the formula R²(OCHCH₂)ₘOH wherein m has an average value from 5 to 15 and R² is a C₁₃₋₁₈ alkyl or a combination of C₁₃₋₁₈ alkyl;
1 to 20 weight percent of a cosolvent; and
the remainder water.

2. The surfactant concentrate of claim 1, wherein the composition does not include an alkylphenol ethoxylate or an anionic surfactant.

3. The surfactant concentrate of claim 1, wherein n is from 3 to 10.

4. The surfactant concentrate of claim 1, wherein n is from 7 to 10.

5. The surfactant concentrate of claim 1, wherein n is from 8 to

10.

6. The surfactant concentrate of claim 1, wherein m is from 5 to 12.

7. The surfactant concentrate of claim 6, wherein m is from 7 to 10.

8. The surfactant concentrate of claim 1, wherein the compatibilizer is a glycol ether.

9. A surfactant concentrate comprising, based on the total weight of the concentrate,
5 to 30 weight percent of a surfactant of the formula R¹(OCHCH₂)ₙOH wherein n has an average value of 9 and R¹ is a combination of C₁₂₋₁₄ alkyl having an average value of C₁₃ or higher;
10 to 60 weight percent of a surfactant of the formula R²(OCHCH₂)ₘOH wherein m has an average value from 5 to 12 and R² is a C₁₃₋₁₈ alkyl or a combination of C₁₃₋₁₈ alkyl;
5 to 15 weight percent of a cosolvent; and
the remainder water.

10. A scouring bath composition for a textile, comprising
1 to 20 weight percent of the surfactant concentrate of claim 1; and
0.1 to 10 weight percent of an oxidant; an amount of base effective to provide a basic pH; and
the reminder water.

11. A method of scouring a textile, comprising
contacting the textile with the scouring bath composition of claim 10 for a time and at a temperature effective to scour the textile.

12. The method of claim 11, wherein a cotton fabric scoured in the scouring bath composition containing the surfactants has a result in the absorbency test AATCC no. 79-2007 of 6.0 seconds or less.

13. The method of claim 11, wherein a cotton fabric scoured in the scouring bath composition containing the surfactants has a result in the absorbency test AATCC no. 79-2007 of 1.0 seconds or less.

14. The method of claim 11, wherein a cotton fabric scoured in the scouring bath composition containing the surfactants, has a result in the wicking test AATCC no. 197-2011 of 320.0 seconds or less.

15. The method of claim 14, wherein a cotton fabric scoured in the scouring bath composition containing the surfactants has a result in the wicking test AATCC no. 197-2011 of 200.0 seconds or less.

16. The scouring bath composition of claim 10, wherein the oxidant is a peroxide or a hypochloride.

17. The method of claim 12, wherein the scouring bath composition comprises 0.05% to 0.4% of the surfactants.
